(19) United States
(12) Patent Application Publication
(10) Pub. No.: US 2022/0291925 A1
(43) Pub. Date: Sep. 15, 2022

(54) PARAMETRIC FILTER USING HASH FUNCTIONS WITH IMPROVED TIME AND MEMORY

(71) Applicant: RAYTHEON BBN TECHNOLOGIES, CORP., Cambridge, MA (US)

(72) Inventor: Andrew Phillips Wagner, Brighton, MA (US)

(21) Appl. No.: 17/674,710

(22) Filed: Feb. 17, 2022

Related U.S. Application Data
(60) Provisional application No. 63/160,418, filed on Mar. 12, 2021.

(51) Int. Cl. G06F 9/30

(52) U.S. Cl. CPC G06F 9/30036; G06F 9/3004; G06F 9/30032

(57) ABSTRACT

Method for searching an item using a parametric hash filter includes forming an input vector from input data stream; forming a hash matrix having a first portion and a second portion; multiplying the hash matrix with the input vector to generate a second input vector including a hash values of the first input vector; generating a perfect hash vector and a universal hash vector, by applying a smooth periodic function to the second input vector; mapping onto a Markov random field the coordinates of locations of hash values in a search domain for which there is no possibility of collisions in the perfect hash vector to form an energy function; minimizing the energy function to generate a compressed hash table; fitting a band of acceptable locations in the compressed hash table, based on a predetermined false positive rate; and searching for a new item in the band of acceptable locations.

### CROSS-REFERENCE TO RELATED APPLICATIONS

This patent application claims the benefits of U.S. Provisional Patent Application Ser. No. 63/160,418, filed on Mar. 12, 2021 and entitled “Perfect Parametric Filter,” the entire content of which is hereby expressly incorporated by reference.

### FIELD OF THE INVENTION

The disclosed invention generally relates to parametric filters and more specifically to a perfect parametric filter, utilizing hash functions.

### BACKGROUND

Filters and search operations for data based on data strings, symbols or other features in a large search space, such as World Wide Web, are increasing utilized at individual, enterprise and government levels. For instance, deep packet inspection (DPI) requires the identification of specific strings in increasingly wide pipes of data. Presently, 100 Gbps line speed is common and will only increase significantly over time.

Furthermore, the search space is increasing in both size and complexity. For example, vast quantities of Geo-intelligence data are acquired by numerous satellite arrays, each collecting 10 or more TB (terabytes) of data daily. Also, many companies and government agencies have archival data measured in the 100s of PB (petabytes). Additionally, personal digital cameras produce approximately 1.5 trillion images each year globally, some fraction of which may contain valuable intelligence. Efficiently searching and matching these data bases either as streaming data captured live, or as a search over archival data, is critical for the timely delivery of actionable intelligence data to analysts.

Most of the current searches are based on hashing functions that map objects in a universe to a finite set of keys for lookup. Different hash function constructions have different properties ranging from uniformly distributed universal hash functions, to locality sensitive hash functions that attempt to preserve the distance between two objects in the mapped keys. Directly matching elements in search domains is commonly achieved with a Bloom filter or one of its variants which consumes O(N) memory resources. This scaling is adequate for relatively small search list sizes or search bandwidths, but when either becomes sufficiently large the linear scaling of such searches can exceed the available memory bandwidth of existing computing platforms.

A Bloom filter is a space-efficient probabilistic data structure that is used to test whether an element is a member of a (search) set. False positive matches are possible in a Bloom filter method, but false negatives are not, that is, a query returns either “possibly in set” or “definitely not in set”. Elements can be added to the set, but not removed and the more items added, the larger the probability of false positives. With sufficient core memory, which may be a limiting factor in the system design, an error-free hash may be used to eliminate some unnecessary disk accesses.

FIG. 1 illustrate an example of a Bloom filter that represents the set {x, y, z}. The arrow sets show the positions in the bit array that each set element is mapped to. The element w is not in the set {x, y, z}, because it hashes to one bit-array position containing 0.

Bloom filters provide an O(1) search time algorithm that is to some extent memory efficient,

[symbol]

(−1.44n log ϵ)

where epsilon is the false positive rate and n is the search list size, both system or application parameters based on the application and system requirements.

However, for example, a 10\hat{ }7 data string would require ˜14 Mbits of memory for a 50% false positive rate, or about 14 times the size of the available SRAM on a modern field-programmable gate array (FPGA) for 100 Gbps line rates. In the near future, inspection requirements may overwhelm the available fast memory on FPGAs and other electronic circuits.

Moreover, all of the existing approaches suffer from O(N) or worse memory resource complexity. Here N denotes the number of objects/items in a search space (list), and might include image feature vectors, keywords or other search data of interest. The relatively poor scaling of resource complexity with N creates memory bandwidth bottlenecks in search applications as list sizes and data rates become large. This fact severely limits the effectiveness of the automated collection and timely delivery of data and searching results.

### SUMMARY OF THE INVENTION

In some embodiments, the present approach compresses the matching criteria in a filter exponentially better than existing techniques to enable search capabilities on a scale and speed that was previously not possible. For instance, analysts can easily geolocate images stripped of meta-data or search for rare objects by processing the feature vectors of relevant images through the perfect parametric filter of the present disclosure. Alternatively, analysts could track many millions of features simultaneously in real-time using data from a global satellite network.

In some embodiments, the present approach is directed to a method for searching an item in a search domain using a parametric hash filter. The method, executed by one or more processors, includes: receiving the item in a data stream; forming a first data structure as an input vector from the data stream; forming a second data structure as a hash matrix having a first portion and a second portion; multiplying the hash matrix with the input vector to generate a second input vector including a data structure for hash values of the first input vector; generating a third data structure for a perfect hash vector including coordinates of locations of hash values in the search domain for which there is no possibility of collisions and a fourth data structure for a universal hash vector including coordinates of locations of hash values in the search domain for which there is a possibility of collisions, by applying a smooth periodic function to the second input vector, wherein the first portion of the hash matrix ensures that there is no possibility of collisions between the hash values in the search domain; mapping onto a Markov random field the coordinates of locations of hash values in the search domain for which there is no possibility of collisions in the perfect hash vector to form an energy function; minimizing the energy function to generate a compressed hash table; fitting a band of acceptable locations in the compressed hash table, based on a predetermined false positive rate; and searching for a new item in the band of acceptable locations.

In some embodiments, the present approach is directed to a parametric hash filter for searching an item in a search domain. The parametric hash filter includes an input circuit for receiving the item in a data stream; a shift register for forming a first data structure as an input vector from the data stream; matrix circuitries for forming a hash matrix having a first portion and a second portion; a matrix multiplier for multiplying the hash matrix with the input vector to generate a second input vector including a data structure for hash values of the first input vector; and a controller for generating a third data structure for a perfect hash vector including coordinates of locations of hash values in the search domain for which there is no possibility of collisions and a fourth data structure for a universal hash vector including coordinates of locations of hash values in the search domain for which there is a possibility of collisions, by applying a smooth periodic function to the second input vector, wherein the first portion of the hash matrix ensures that there is no possibility of collisions between the hash values in the search domain. The controller maps the coordinates of locations of hash values in the search domain for which there is no possibility of collisions in the perfect hash vector onto a Markov random field to form an energy function; minimizes the energy function to generate a compressed hash table; and fits a band of acceptable locations in the compressed hash table, based on a predetermined false positive rate. A new item is then searched in the band of acceptable locations.

Minimizing the energy function may be executed by plugging in Δ in the energy function, where Δ is slope of each nearest neighbor value in the hash matrix, by mapping the hash matrix onto a Markov random field, using a numerical minimization software library (MINUIT), or using a steepest descent minimization approach.

The membership in the search domain may then be determined by evaluating the band of acceptable locations for a given input and comparing the value of Q′ to a function of P, by verifying |f(P)−Q′|<δ where δ is chosen to satisfy a predetermined false positive rate ϵ, where Q′ and P are hash keys.

### BRIEF DESCRIPTION OF THE DRAWINGS

A more complete appreciation of the disclosure, and many of the attendant features and aspects thereof, will become more readily apparent as the disclosure becomes better understood by reference to the following detailed description when considered in conjunction with the accompanying drawings in which like reference symbols indicate like components.

FIG. 1 illustrate an example of a Bloom filter, according to prior art.

FIG. 2 diagrammatically shows an exemplary hash matrix multiplied by an input vector to generate two hash vectors, according to some embodiments of the disclosed invention.

FIG. 3A shows a hash table with a random distribution of values of key Q relative to key P, according to some embodiments of the disclosed invention.

FIG. 3B depicts a smoothen hash table when a periodic function is applied to the hash table of FIG. 3A, according to some embodiments of the disclosed invention.

FIG. 3C illustrates a compressed hash table by minimizing an energy function of the hash table of FIG. 3B, according to some embodiments of the disclosed invention.

FIG. 3D shows an optimized hash table when a band of acceptable locations is fit into the compressed hash table of FIG. 3C, according to some embodiments of the disclosed invention.

FIG. 4 is an exemplary process flow for a parametric hash filter, according to some embodiments of the disclosed invention.

FIG. 5 is an exemplary block diagram for a parametric hash filter, according to some embodiments of the disclosed invention.

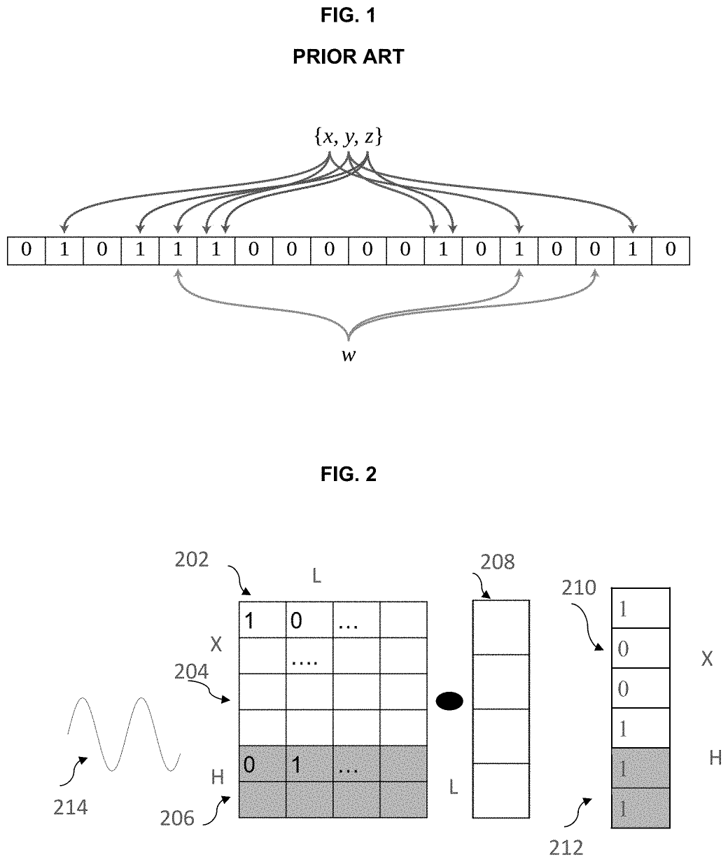

### DETAILED DESCRIPTION

In some embodiments, the present disclosure is directed to a parametric hash filter and a method for ultra-fast searching with improved memory requirements. The filter of the present approach compresses the matching criteria to enable search capabilities for analysts on a scale and speed that was previously not possible. In some embodiments, this compression is achieved with the matrix construction of a universal hash function where a smooth periodic function is applied to the product of the matrix with an input data vector. The smooth periodic function permits the parameters of the matrix to be trained so that a compression of the resulting hash table is achieved. The lookup is then accommodated by the evaluation of a parametric function of constant complexity.

In some embodiments, the parametric hash filter and filtering process of the present disclosure returns matches in real-time as they occur, permitting a pipelined analysis of filter matches. These approaches to using the parametric hash filter facilitates complex searching and matching applications in real-time, such as, rare object detection in streaming data and coarse filtering for object location matching with no metadata.

In some embodiments, the parametric hash filter of the present disclosure encodes the data in the search space in a hash function table. Each element of data stored in the hash function table is encoded in a single bin in the table. The hash function table is then compressed based on optimization of an energy functions, as described below. Matching is achieved by computing the optimized hash function for data in an input stream and checking that the encoded parametric relationship in the search space is satisfied. This lookup takes constant time and consumes only O(log(N)²) resources, such as memory and hardware resources.

As described above, the hash function is the matrix and the smooth periodic function, where the output of the hash function over all items in the search list generates the hash table as a data structure.

The construction of the hash matrix for the parametric hash filter is similar to the typical construction of a hash table using universal hash functions derived from a random binary matrix, as described in detail in J. L. Carter and M. N. Wegman, “Universal classes of hash functions,” Journal of Computer and System Sciences, vol. 18, pp. 143-154, 1978, doi: 10.1016/0022-0000(79)90044-8; and A. Broder and M. M. I. mathematics, “Network applications of bloom filters: A survey,” Internet Mathematics, vol. 1, no. 4, pp. 485-509, 2004, doi: 10.1080/15427951.2004.10129096; and entire contents of which are herein expressly incorporated by reference.

In some embodiments, the hashing function (the composition of the matrix and periodic function) takes [symbol] (log N) bits to describe it. The dimensions of the matrix in the present hash function can then be quantified including the additional universal hash function for the filter process.

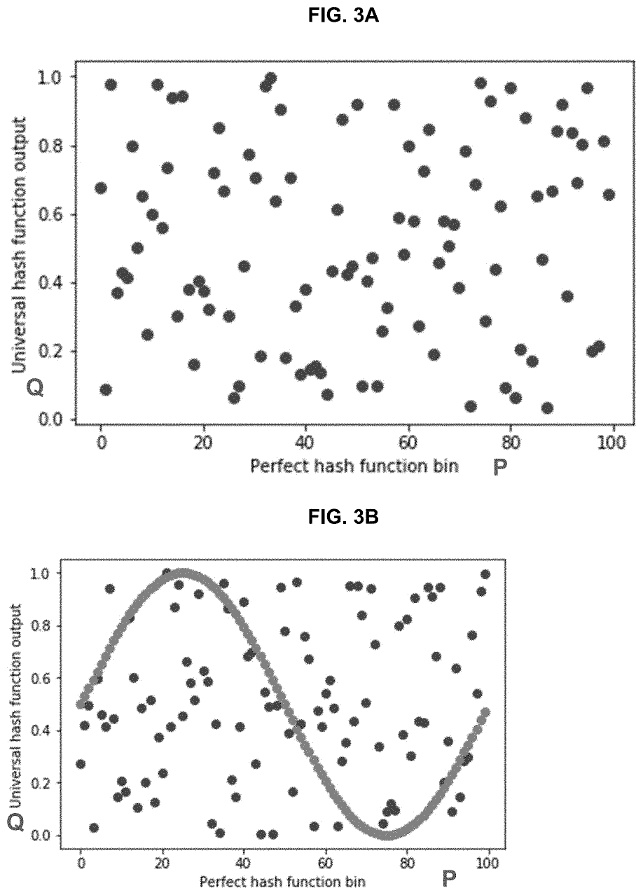

FIG. 2 diagrammatically shows an exemplary hash matrix multiplied by an input vector to generate two hash vectors, according to some embodiments of the disclosure. As shown, a hash matrix 202 with L number of columns and (X+H) number of rows is multiplied by an input vector 208 of length L to generate a second (intermediate) input vector (not shown) that includes hash values of the first input vector. Matrix 202 includes a first portion 204 and a second portion 206. The first portion 204 includes X number of rows and the second portion includes H number of rows. L is the input vector length in bits, X is log(N) where N is the number of objects (in the list being searched for) in the filter, and H is −log(e) where e is the false positive rate. The values in the hash function matrix encode the position of search objects within the hash table. The values in aggregate define the hash function output and hence the hash table.

A smooth periodic function 214 is applied to (acted on) the second (intermediate) input vector to generate a first hash vectors 210 and a second hash vector 212. The first hash vector 210 is a perfect hash vector meaning that it includes coordinates of locations of hash values in the search domain (how are these locations relate to the matrix) for which there is no possibility of collisions. Generally, a collision occurs when two different inputs produce the same hash function output. Alternatively, two different inputs may exist in the same bin in the hash table producing a collision. The second hash vector 212 is a universal hash vector that includes coordinates of locations of hash values in the search domain for which there is a possibility of collisions. The first portion 204 of the matrix 202 ensures that there is no possibility of collisions between the hash values in the search domain and is used to generate the perfect hash vector 210 with a length of L. The second portion 206 of the matrix 202 generates the second hash vector 212212. Together, the first hash vector 210 and the second hash vector 212 define the coordinates of an item in the hash table.

Since a list of size N needs to be accommodated with a given false positive rate,

$$X = log ( N ) and H ∝ log ( \frac{1}{ϵ} ) .$$

This process produces a log(N) bit key P, and an

$$O ( log ( \frac{1}{ϵ} ) )$$

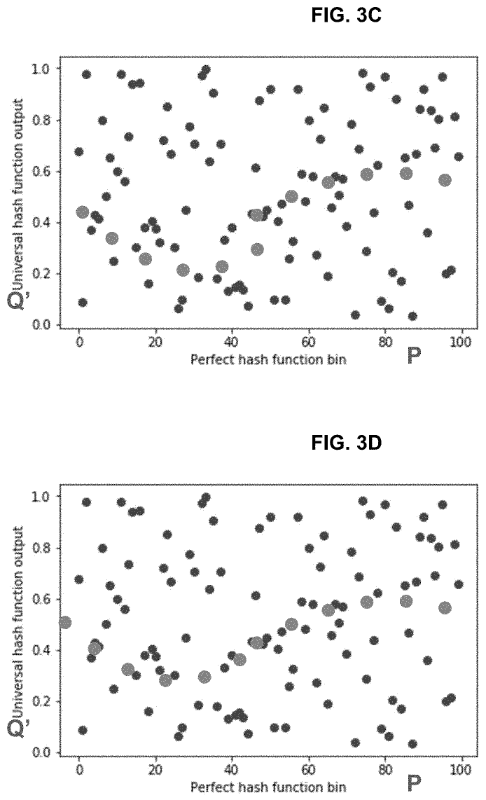

bit Key Q, which are used as the “X” axis and “Y’ axis of the hash tables shown in FIGS. 3A-3C. The resulting hash table produces a random distribution of values for the keys Q relative to P, since the matrix entries are random, as shown in FIG. 3A. In some embodiments, the entries of the hash matrix and input vector need not be binary and could be any real numbers.

However, the universal hash function doesn't need to be unique for the inputs like the perfect hash function, thus in principle, there is a significant amount of compression that can be performed to cut down the amount of memory used. This can be achieved by realizing the perfect hash function to define a pseudo time series (such as, a smooth periodic function, or any smooth function) on the input data. If the second hash function can be trained to produce a good fit to a simple function, then a significant compression of the filter is achieved. In general, the filter looks like white noise at first, as shown in FIG. 3A.

When a smooth periodic function, such as a sinusoid is applied to the first hash function bin of FIG. 3A, the filter is compressed into a narrower bandwidth, as shown in FIG. 3B. However, fitting the search elements into this compressed narrower bandwidth hash bin (i.e., a single element in the hash table) of FIG. 3B, is very computationally complex. Since the items in the search list may be random vectors, picking a particular function to fit beforehand may not fit the hash table very well. The search list will in general generate high and low frequency components, which makes the computation complex.

The compressed narrower bandwidth hash bin is further compressed and optimized by minimizing an energy function of the table of hash keys P and Q, for example, by plugging in Δ in the energy function, using known minimization methods, where Δ is the slope of each nearest neighbor value in the hash table.

In some embodiment, the energy function “E” is minimized by plugging A, as shown in equations (1) and (2) below.

$$E = {\sum }_{i , i + 1} \frac{1}{1 + {e}^{β {Δ}_{i , i + 1}^{2}}} \qquad ( 1 )$$

$${Δ}_{i , i + 1} = \frac{{U}_{i} - {U}_{i + 1}}{{P}_{i} - {P}_{i + 1}} \qquad ( 2 )$$

The minimization of the energy function in Equation (1) ensures that if neighboring elements in the hash table are too far apart, the minimizing energy function penalizes that.

In some embodiment, the parametric hash filter significantly reduces the resources required to perform a lookup operation by minimizing the energy function via mapping a hash table onto a Markov random field. As known in the art, a Markov random field (MRF) is a set of random variables having a Markov property described by an undirected graph. In other words, a random field is said to be a Markov random field if it satisfies Markov properties. In some embodiment, the parametric hash filter varies the last

$$log ( \frac{1}{ϵ} )$$

rows of the hashing matrix to find parameters that minimize the Markov energy function when the hash outputs keys P and Q that are plotted against each other as shown in FIGS. 3A-3C.

This optimization is possible since the typical modulus function used in the construction of binary universal hashing functions is replaced by a smooth periodic function permitting the use of gradient descent techniques to locate a suitable minima of the energy function. As known in the art, gradient descent (also often called steepest descent) is a first-order iterative optimization technique for finding a local minimum of a differentiable function. The technique takes repeated steps in the opposite direction of the gradient (or approximate gradient) of the function at the current point, because this is the direction of steepest descent. Conversely, stepping in the direction of the gradient leads to a local maximum of that function.

The result of this optimization process are new hash values Q′ that approximate a parametric function when plotted against P, as shown in FIG. 3C. This process affects a compression of the hash table for objects in the search list optimized with this process since now membership in the search list is determined by evaluating the optimized filter for a given input and comparing the value of Q′ to a function of P, namely verifying |f(P)−Q′|<δ where δ is chosen to satisfy a given false positive rate ϵ. Here, the function f forms the band. An item is then fit to the coordinates of the hash table and the values of the hash table within the band are checked to search for the item.

In some embodiments, the minimization process is similar to back propagation training in machine learning. The result is a smoothed “near DC” hash that might contain some higher frequency components if present in the original hash, as depicted in FIG. 2C. For example, MINUIT (a numerical minimization software library) or other methods method of steepest descent program, may be used to execute the energy minimization. This new smooth hash is much more compressed and less clustered.

Next, a band of acceptable locations is determined based on the system restrictions/requirements for positive false rate E and fit into the smooth hash table, as shown in FIG. 3D (Note, the band is not shown in FIG. 3D yet). For instance, a straight line may be fit to the data, then the maximum distance of the points in the hash table is computed to the line and all hash bins with the bound described by the maximum distance are accepted.

The membership in the search domain is now determined by evaluating the optimized filter for a given input and comparing the value of Q′ to a function of P, namely verifying |f(P)−Q′|<δ where δ is chosen to satisfy a given false positive rate ϵ.

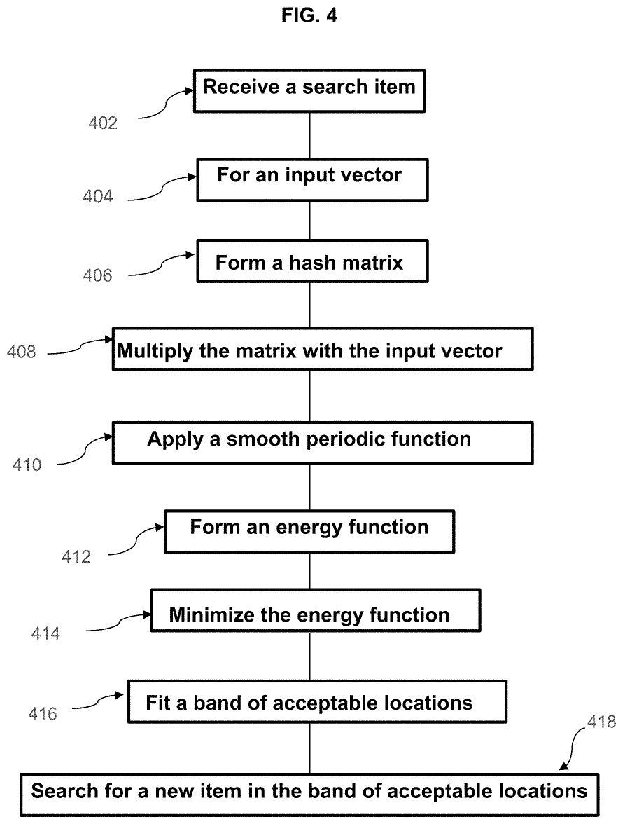

FIG. 4 is an exemplary process flow for a parametric hash filter, according to some embodiments of the disclosed invention. As shown in block 402, an item to be searched is received by the parametric hash filter, for example, in a data stream. The data stream may be received in real time from a data source, such as one or more satellites or sensors, or may be retrieved from a memory device. The search item may be for a rare object detection in the data stream and coarse filtering for object location matching with no metadata, for example, in a Geo-intelligence application.

In block 404, a first data structure is formed as an input vector is formed from the data stream, representing the input data in the input vector. In block 406, a second data structure is formed as a hash matrix having a first portion and a second portion. As explained above, the first portion is a perfect hash function and the second portion is a universal hash function. The first portion of the hash matrix ensures that there is no possibility of collisions between the hash values in the search domain. In some embodiments, the hash matrix takes [symbol] (log N) bits to describe it. As explained above and will be explained below, the unique data structures of the parametric hash filter, generated by one or more processors, enable ultra-fast searching with improved memory requirements for the parametric hash table, which is used in and improves upon numerous applications and technologies for complicated data searching, including baseline application behavior, network usage analysis, network performance troubleshooting, data and network security, checking for malicious code, eavesdropping, internet censorship, and a wide range of other applications, at the enterprise level, telecommunications service providers, governments, and the like.

In block 408, the hash matrix is multiplied with the input vector to generate data structure for a second input vector, which includes hash values of the first input vector. A smooth periodic function is acted on (applied to) the second input vector to generate unique data structures for perfect hash vector and a universal hash vector, in block 410. The perfect hash vector includes coordinates of locations of hash values in the search domain for which there is no possibility of collisions and the universal hash vector includes coordinates of locations of hash values in the search domain for which there is a possibility of collisions.

In block 412, an energy function is formed by mapping the coordinates of locations of hash values in the search domain for which there is no possibility of collisions in the perfect hash vector onto a Markov random field. The energy function is formed based on the table of hash key P and Q. The parametric hash filter may be varied over the last

$$log ( \frac{1}{ϵ} )$$

rows of the hashing matrix to find parameters that minimize the Markov energy function when the hash outputs P and Q are plotted against each other as shown in FIGS. 3A-3C. In block 414, the energy function is minimized to generate a compressed hash table. The energy function of the table of hash key P and Q is minimized, for example, by plugging in Δ in the energy function, using known minimization methods, where Δ is the slope of each nearest neighbor value in the hash table. It is noted that the energy function minimization effects only the universal portion of the hash matrix and thus the values of the universal hash vector.

In block 416, a band of acceptable locations is fit into the compressed hash table, based on a predetermined false positive rate. Then, a search for a new item in the band of acceptable locations may be performed, as shown in block 418.

As recognized by pone skilled in the art, the parametric hash filter and the filtering process of the present disclosure may be implemented by software, hardware such as one or more FPGAs, firmware, neural networks, or in combination thereof. Similarly, the process flow for a parametric hash filter of FIG. 4 may be executed by a parametric hash filter implemented as such. For example, the parametric hash filter can be deployed at a network edge that is collated with various sensors. The filter can be trained with any set of keywords or symbols enabling it to filter a diverse set of Geo-intelligence data including large databases and high-throughput streaming media.

An echo-state network with random input and network weights and periodic activation function assumed as a universal hashing function. Accordingly, this approach to generating universal hashing functions can be realized in a mathematical model for dynamical systems called an Echo-State network, where the keys are the inputs u, the matrices are random floating-point numbers and the activation function is the periodic function. For hardware implementation of echo-state networks, the matrix multiplication and activation function are executed by the dynamics of the physical circuit.

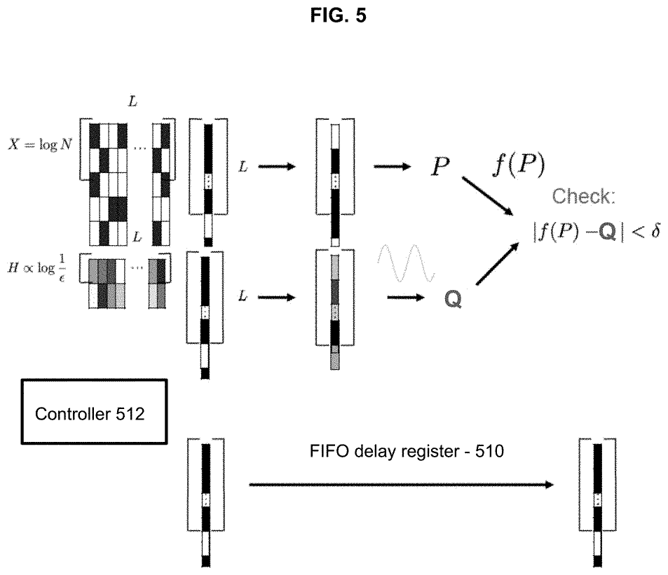

FIG. 5 is an exemplary block diagram for a parametric hash filter, according to some embodiments of the disclosed invention. In some embodiment, the parametric hash filter can be efficiently decomposed into binary and fixed-point matrix operations to optimize performance on FPGAs, as shown in FIG. 5. The filter includes known electronic circuits for receiving the input data and forming the input data in a vector, for example, one or more FIFOs, or shift registers. The filter also includes known matrix multiplication circuits for performing matrix and vector additions and multiplications. As shown, a binary feature vector of L bits is multiplied separately by an L×X binary matrix and L×H fixed point precision matrix. The matrixes may be formed by matrix circuitries, such as a combination of FIFOs and memory devices. Filter operations to produce the hash keys proceed in parallel and the filer check is performed, for example. by a controller 512 verifying |f(P)−Q′|<δ where δ is chosen to satisfy a given false positive rate ϵ. A copy of the feature vector may be stored in a FIFO delay register 510 and returned if the feature vector is a match to the filter.

Controller 512 generates a third data structure for a perfect hash vector including coordinates of locations of hash values in the search domain for which there is no possibility of collisions and a fourth data structure for a universal hash vector including coordinates of locations of hash values in the search domain for which there is a possibility of collisions, by applying a smooth periodic function to the second input vector, wherein the first portion of the hash matrix ensures that there is no possibility of collisions between the hash values in the search domain. Controller 512 further maps the coordinates of locations of hash values in the search domain for which there is no possibility of collisions in the perfect hash vector onto a Markov random field to form an energy function, minimizes the energy function to generate a compressed hash table; and fits a band of acceptable locations in the compressed hash table, based on a predetermined false positive rate. A new item may then be searched in the band of acceptable locations.

Binary matrix operations can be efficiently implemented by combinatorial logic circuits (multipliers and/or adders) performing bitwise AND operations for each row of hash matrix with the corresponding bits in the input vector and then performing XOR operations on each row of the result. Fixed point precision matrix operations and composition with a smooth periodic function need only be performed with the last H rows of the hash matrix. Again, the use of binary feature vectors can dramatically reduce the resource overhead of the filter algorithm since multiplication of the fixed-point matrix with a binary vector can be replaced by a sum over the elements in each row of the hash matrix that are not multiplied by a 0 in the vector. This saves many resource intensive multiplication operations. When the input vector passes the filter, it is output by the FPGA from the FIFO delay register 510.

Accordingly, the resources required to implement the hash function can be readily accommodated on modern FPGA and other hardware implementations. One concrete application for the parametric hash filter is searching for the location of rare objects with only a few examples. Given even a few examples of any object, the image features of that object can be compiled into the parametric hash filter. Even smaller search list sizes can benefit from the present parametric hash filter implementation since many more copies of the filter can fit in the same amount of system resources. Implementing multiple copies of the filter inside an FPGA or even across several FPGAs and running them at, for example, 300 MHz+ clock rates, achieves ultra-fast data processing rates only limited by input/output (I/O) bandwidth of the hardware rather than by the memory resources.

The filter and filtering process of the present disclosure may be used for deep packet inspection (DPI), which is a type of data processing that in detail inspects the data being sent over a computer network, and may take actions such as alerting, blocking, re-routing, or logging it accordingly. The filter and filtering process of the present disclosure improves upon various applications and technologies, including baseline application behavior, network usage analysis, network performance troubleshooting, data and network security, ensuring that data is in the correct format, checking for malicious code, eavesdropping, internet censorship, and a wide range of other applications, at the enterprise level, telecommunications service providers, governments, and the like. The filter and filtering process of the present disclosure can be deployed at the network edge that may be collated with sensors.

It will be recognized by those skilled in the art that various modifications may be made to the illustrated and other embodiments of the filter and filtering method described above, without departing from the broad inventive scope thereof. It will be understood therefore that the disclosure is not limited to the particular embodiments or arrangements disclosed, but is rather intended to cover any changes, adaptations or modifications which are within the scope of the disclosure as defined by the appended claims and drawings.

1. A method for searching an item in a search domain using a parametric hash filter, the method comprising:
receiving the item in a data stream;
forming an input vector from the data stream;
forming a second data structure as a hash matrix having a first portion and a second portion;
multiplying the hash matrix with the input vector to generate a second input vector including a data structure for hash values of the first input vector;
generating a third data structure for a perfect hash vector including coordinates of locations of hash values in the search domain for which there is no possibility of collisions and a fourth data structure for a universal hash vector including coordinates of locations of hash values in the search domain for which there is a possibility of collisions, by applying a smooth periodic function to the second input vector, wherein the first portion of the hash matrix ensures that there is no possibility of collisions between the hash values in the search domain;
mapping onto a Markov random field the coordinates of locations of hash values in the search domain for which there is no possibility of collisions in the perfect hash vector to form an energy function;
minimizing the energy function to generate a compressed hash table;
fitting a band of acceptable locations in the compressed hash table, based on a predetermined false positive rate; and
searching for a new item in the band of acceptable locations.

2. The method of claim 1, wherein minimizing the energy function is executed by plugging in Δ in the energy function, where Δ is slope of each nearest neighbor value in the hash matrix.

3. The method of claim 1, wherein minimizing the energy function is executed by mapping the hash matrix onto a Markov random field.

4. The method of claim 1, wherein minimizing the energy function is executed using a numerical minimization software library (MINUIT).

5. The method of claim 1, wherein minimizing the energy function is executed using a steepest descent minimization approach.

6. The method of claim 1, wherein the parametric hash filter varies a last
$$log ( \frac{1}{ϵ} )$$
rows of the hash matrix to find parameters that minimize a Markov energy function, where E is a predetermined false positive rate.

7. The method of claim 1, wherein membership in the search domain is determined by evaluating the band of acceptable locations for a given input and comparing the value of Q′ to a function of P, by verifying |f(P)−Q′|<δ where δ is chosen to satisfy a predetermined false positive rate ϵ, where Q′ and P are hash keys.

8. A parametric hash filter for searching an item in a search domain, comprising:
an input circuit for receiving the item in a data stream;
a shift register for forming a first data structure as an input vector from the data stream;
matrix circuitries for forming a hash matrix having a first portion and a second portion;
a matrix multiplier for multiplying the hash matrix with the input vector to generate a second input vector including a data structure for hash values of the first input vector; and
a controller for generating a third data structure for a perfect hash vector including coordinates of locations of hash values in the search domain for which there is no possibility of collisions and a fourth data structure for a universal hash vector including coordinates of locations of hash values in the search domain for which there is a possibility of collisions, by applying a smooth periodic function to the second input vector, wherein the first portion of the hash matrix ensures that there is no possibility of collisions between the hash values in the search domain, wherein the controller maps the coordinates of locations of hash values in the search domain for which there is no possibility of collisions in the perfect hash vector onto a Markov random field to form an energy function; minimizes the energy function to generate a compressed hash table; and fits a band of acceptable locations in the compressed hash table, based on a predetermined false positive rate, and wherein
a new item is searched in the band of acceptable locations.

9. The parametric hash filter of claim 8, wherein minimizing the energy function is executed by plugging in Δ in the energy function, where Δ is slope of each nearest neighbor value in the hash matrix.

10. The parametric hash filter of claim 8, wherein minimizing the energy function is executed by mapping the hash matrix onto a Markov random field.

11. The parametric hash filter of claim 8, wherein minimizing the energy function is executed using a numerical minimization software library (MINUIT).

12. The parametric hash filter of claim 8, wherein minimizing the energy function is executed using a steepest descent minimization approach.

13. The parametric hash filter of claim 8, wherein the parametric hash filter varies a last
$$log ( \frac{1}{ϵ} )$$
rows of the hash matrix to find parameters that minimize a Markov energy function, where E is a predetermined false positive rate.

14. The parametric hash filter of claim 8, wherein membership in the search domain is determined by evaluating the band of acceptable locations for a given input and comparing the value of Q′ to a function of P, by verifying |f(P)−Q′|<δ where δ is chosen to satisfy a predetermined false positive rate ϵ, where Q′ and P are hash keys.
